(19) United States
(12) Patent Application Publication
(10) Pub. No.: US 2017/0279657 A1
(43) Pub. Date: Sep. 28, 2017

(54) COMMUNICATING BETWEEN COMPONENTS IN BUSINESS PROCESS MANAGEMENT SYSTEMS

(71) Applicant: International Business Machines Corporation, Armonk, NY (US)

(72) Inventors: Douglas J. Cowie, Winchester (GB); Anthony A. Garrard, Bournemouth (GB); Nicolas S. Townsend, Southampton (GB)

(21) Appl. No.: 15/077,274

(22) Filed: Mar. 22, 2016

(51) Int. Cl. H04L 12/24; H04L 29/08

(52) U.S. Cl. CPC H04L 41/0226; H04L 67/02

(57) ABSTRACT

An embodiment of the invention may include a method, computer program product and computer system for communicating information between components in a business process management system. The embodiment may include generating a business object including fields and corresponding notification handlers. The notification handlers may be configured to identify a change in a value stored in the corresponding field. The embodiment may include determining an update of a field of a first component. The first component includes fields bound to corresponding fields of the business object. The embodiment may include receiving the updated field from the first component. The embodiment may include updating the corresponding field of the business object based on the updated field from the first component. The embodiment may include notifying a second component, bound to the notification handlers, that the field has been updated. The second component performs an action in response to the updated value.

### BACKGROUND

The present invention relates to communicating between components in business process management (BPM) systems.

### BRIEF SUMMARY

An embodiment of the invention may include a method, computer program product and computer system for communicating information between first component and a second component in a business process management system. The embodiment may include generating a business object comprising one or more fields and one or more notification handlers corresponding to each of the one or more fields. Each of the one or more fields may store a value. Each of the one or more notification handlers may be configured to identify a change in the value stored in the corresponding field of the business object. The embodiment may include determining an update of a field of a first component. The first component includes one or more fields corresponding to the one or more fields of the business object. Each of the one or more fields of the first component is bound to the corresponding field of the business object. The embodiment may include receiving the updated field from the first component. The embodiment may include updating the corresponding field of the business object based on the received update from the field of the first component. The embodiment may include the notification handler of the field of the business object notifying a second component that the field has been updated. The second component is bound to the notification handlers of the one or more fields of the business object. The second component performs an action in response to the updated value.

### BRIEF DESCRIPTION OF THE DRAWINGS

Preferred embodiments of the present invention will now be described, by way of example only, with reference to the following drawings in which:

FIG. 1 is a schematic diagram of a business process management system in accordance with a first embodiment of the invention;

FIG. 2 is a schematic diagram of components generated by the business process management system of FIG. 1;

FIG. 3 is a flow chart showing operation of the business process management system of FIG. 1 when generating the components of FIG. 2;

FIG. 4 is a flow chart showing operation of the business process management system of FIG. 1 when the components of FIG. 2 are in operation; and

FIG. 5 is a schematic diagram of components generated by a business process management system in accordance with a second embodiment of the invention; and

FIG. 6 is a block diagram depicting the hardware components of the business process management system of FIG. 1, in accordance with an embodiment of the invention.

### DETAILED DESCRIPTION

Embodiments of the present invention will now be described in detail with reference to the accompanying Figures.

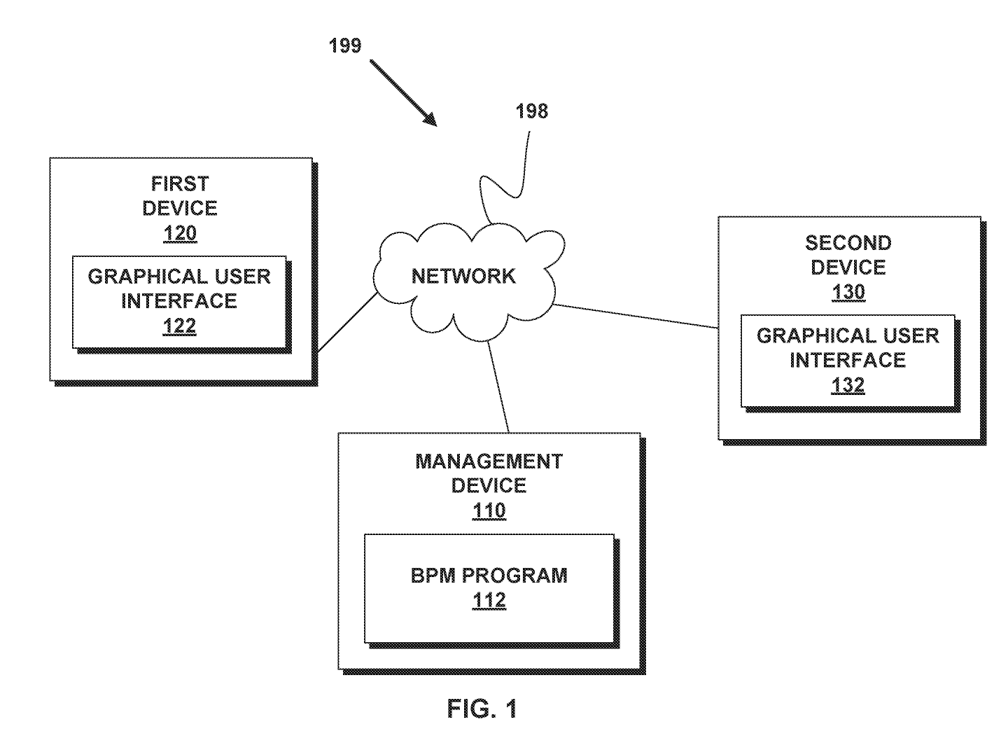

FIG. 1 illustrates business process management system 199, in accordance with an embodiment of the invention. In an example embodiment, business process management system 199 includes a management device 110 and a first device 120 interconnected via a network 198.

In the example embodiment, network 198 is the Internet, representing a worldwide collection of networks and gateways to support communications between devices connected to the Internet. Network 198 may include, for example, wired, wireless or fiber optic connections. In other embodiments, network 198 may be implemented as an intranet, a local area network (LAN), or a wide area network (WAN). In general, network 198 can be any combination of connections and protocols that will support communications between the management device 110 and the first device 120.

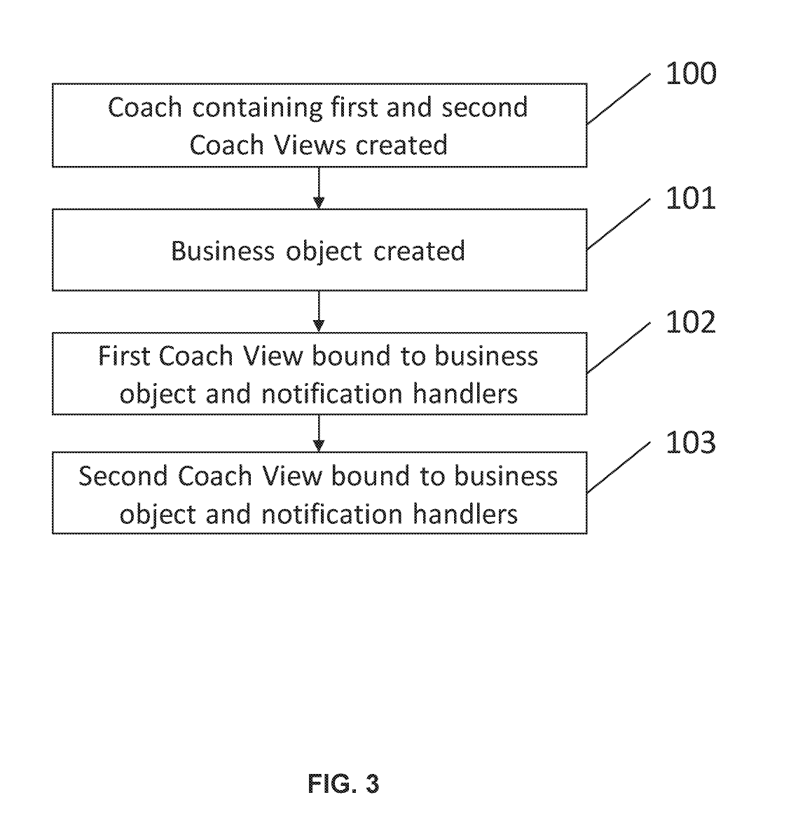

First device 120 may include a graphical user interface (GUI) 122. First device 120 may be a desktop computer, a notebook, a laptop computer, a tablet computer, a handheld device, a smart-phone, a thin client, or any other electronic device or computing system capable of receiving and sending data to and from other computing devices such as management device 110 via network 198. First device 120 is described in more detail with reference to FIG. 3.

Graphical user interface (GUI) 122 represents a user interface for the entry of user created content, or display of information to the user. GUI 122 may represent a standalone application, such as a web browser that interfaces to a network application, for example, BPM program 112.

Second device 130 may include a graphical user interface (GUI) 132. Second device 130 may be a desktop computer, a notebook, a laptop computer, a tablet computer, a handheld device, a smart-phone, a thin client, or any other electronic device or computing system capable of receiving and sending data to and from other computing devices such as management device 110 via network 198. Second device 130 is described in more detail with reference to FIG. 3.

Graphical user interface (GUI) 132 represents a user interface for the entry of user created content, or display of information to the user. GUI 132 may represent a standalone application, such as a web browser that interfaces to a network application, for example, BPM program 112.

Management device 110 includes BPM program 112. In the example embodiment, management device 110 is a desktop computer, a notebook or a laptop computer; however, in other embodiments, management device 110 may be a smart phone, a tablet computer, a handheld device, a thin client, or any other electronic device or computing system capable of receiving and sending data to and from first device 120 via network 198, and capable of operating a graphical user interface. Although not shown, optionally, management device 110 can comprise a cluster of servers executing the same software to collectively manage the incoming and outgoing information. Management device 110 is described in more detail with reference to FIG. 3.

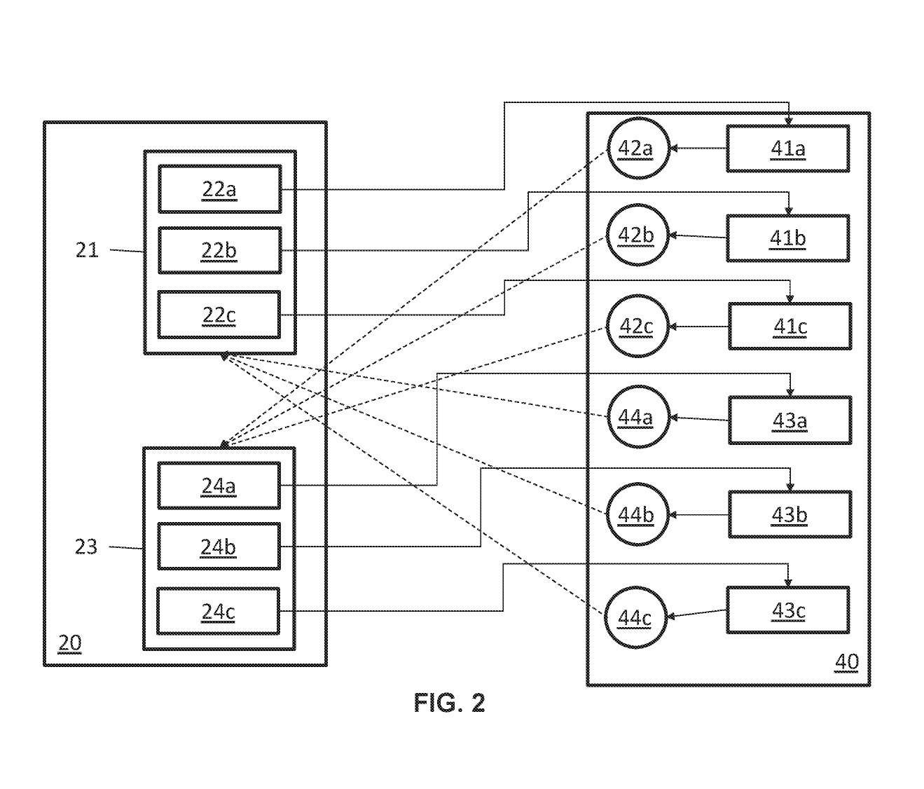

The BPM program 112 implements IBM® Business Process Manager. In operation, the BPM program 112 generates various components, as shown in FIG. 2. A flowchart describing the generation of the components is shown in FIG. 3. IBM is a trademark of International Business Machines Corporation, registered in many jurisdictions worldwide.

The BPM program 112 generates a “Coach” 20 (step 100). The Coach 20 is a web-based user interface (UI) that provides data to, and collects input from, users. The Coach 20 is provided as a web page via GUI 122 and/or GUI 132, and may either be located as part of management device 110, or as an application on first device 120 and second device 130. In instances where coach 20 is located on management device 110, coach 20 communicates with comparable widgets on first device 120 and second device 130.

The Coach 20 comprises Coach Views 21 and 23, corresponding to GUI 122 on first device 120 and GUI 132 on second device 130, respectively. Coach Views are reusable units of a Coach (other units being buttons, display fields etc.) that define sets of data for a Coach to present. A Coach View is a web-based UI widget, comparable to a button on a text box, but it can be made larger for more complicated functionality. In computing a widget is an application that can be installed and executed within a web page by an end user. Typically, a widget (also known, amongst other terms, as a portlet, module, snippet and flake), performs a specific task of processing some fetched data. The Coach View 21 comprises fields 22a, 22b and 22c, each of which stores a data value presented by the Coach 22. Similarly, the Coach View 23 comprises fields 24a, 24b and 24c.

Next, the BPM program 112 generates a business object 40 (step 101). The business object 40 comprises fields 41a, 41b and 41c, which have respective notification handlers 42a, 42b and 42c. Notification handlers (also known as “listeners”) identify when changes are made to values stored in fields that they are configured to monitor. In addition, the business object 40 comprises fields 43a, 43b and 43c, which have respective notification handlers 44a, 44b and 44c.

The Coach View 21 is then bound to the business object 40 (step 102). In particular, the fields 22a, 22b and 22c of the Coach View 21 are bound to the fields 41a, 41b and 41c of the business object 40 respectively, so that the values of the fields 41a, 41b and 41c can be displayed and updated by the Coach View 21. Further, the Coach View 21 is attached to the notification handlers 44a, 44b and 44c of the business object 40, so that it is notified when the values stored in the fields 43a, 43b and 43c of the business object 40 are updated.

In a similar fashion, the Coach View 23 is bound to the business object 40 (step 102). The fields 24a, 24b and 24c of the Coach View 23 are bound to the fields 43a, 43b and 43c of the business object 40 respectively; and the Coach View 23 is attached to the notification handlers 42a, 42b and 42c of the business object 40, so that it is notified when the values stored in the fields 41a, 41b and 41c of the business object 40 are updated.

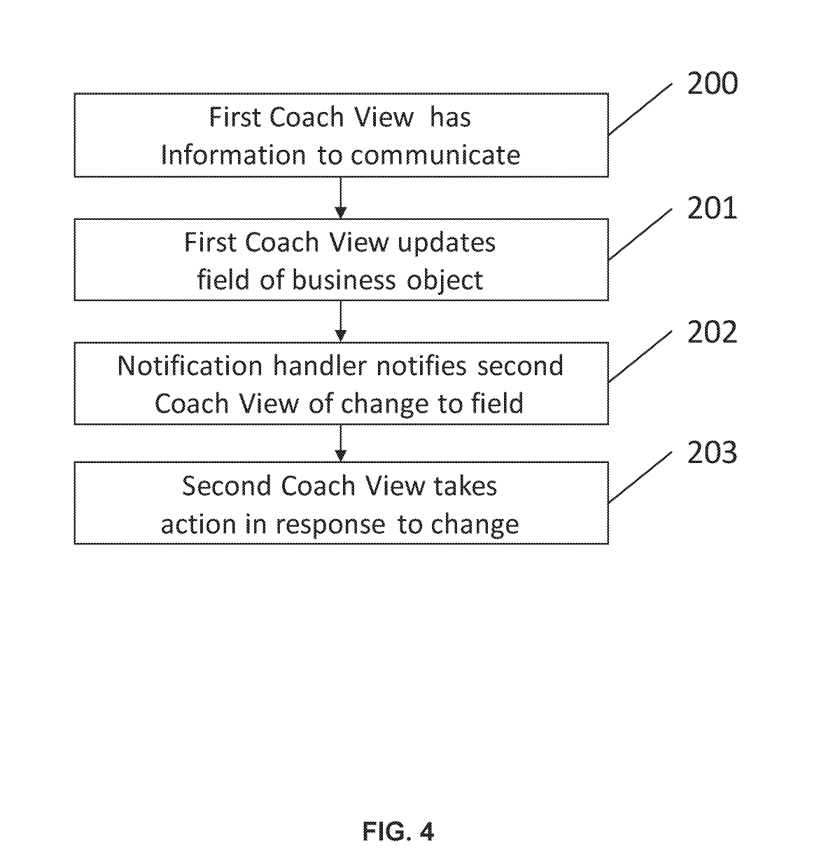

The operation of the BPM program 112 is now described with reference to the flowchart of FIG. 4. The first Coach View 21 of the BPM program 112 determines there is information that to communicate to the Coach View 23 (step 200), or indeed to any other business object. The information may relate to input it has received from the user device 2, for example.

Next, the first Coach View 21 updates a field corresponding to the information to be communicated (step 201). In the present example, the information to be imparted is that a user of the user device has clicked a button of the Coach 20, and to indicate this, the field 22a of the Coach View 21 is updated with an appropriate value. As the field 22a of the Coach View 21 is bound to the field 41a of business object 40, this results in the fields 41a being updated to be the same value.

When the value stored in the field 41a is updated, this is identified by its notification handler 42a. As the second Coach View 23 is attached to the notification handler 42a, it is notified of the update to the field 41a (step 202). The second Coach View 23 is then able to take appropriate action in response to the information represented by the value (step 203).

In this way, the field 41a of the business object 40 acts as a one-directional communications channel by which the first Coach View 21 can communicate information to the second Coach View 23. The fields 41b and 41c can be used as additional one-directional communications channels to transmit other information from the first Coach View 21 to the second Coach View 23, so allowing multiple pieces of information to be communicated simultaneously.

In a similar fashion, the fields 43a, 43b and 43c of the business object 40 and their respective notification handlers 44a, 44b and 44c provide further one-directional communication channels between the first Coach View 21 and second Coach View 23, but in this case allowing information to be passed from the second Coach View 23 to the first Coach View 21. The determination that information is to be passed may be based on a change in the value in first Coach View 21, or may be sent periodically (e.g. once a minute). In this way, communication of information in both directions between the first Coach View 21 and second Coach View 23 is provided.

This communication mechanism can, for example, be used to create responsive user interfaces, by using detailed Coach Views with multiple fields that can pass multiple pieces of information in multiple directions (an example of which is given in more detail below). In this case, the action taken by the second Coach View 23 will be to update the user interface provided by the Coach 20.

Notably, only native BPM objects are required, giving a pluggable, extendable system which can interact natively with other BPM components. This means that communication about events can be shared across process steps, rather than only existing at the Javascript® layer as would be the case if communication was implemented without using native BPM objects. Javascript is a registered trademark of Oracle Corp.

In addition, as the communication is provided by setting values for fields, the information provided persists throughout the flow of a business process, so can be used not only by Coaches but also at other points in the process. Where process execution is performed without leaving a web page, it is possible for other BPM components to send messages to a Coach Views on the screen. By using fields that exist at a larger scope, i.e. above individual business processes, inter-process communication between BPM components is possible.

In alternative embodiments of the invention, a single field of the business object can be bound to fields of both the first Coach View 21 and second Coach View 23, so providing a bi-directional communications channel. However, in this case both the first Coach View 21 and second Coach View 23 would be attached to the notification handler of the field of the business object, so that they would each be notified of changes made to the field by the other Coach View. This would have the undesirable result that they would be notified of their own changes made to the field.

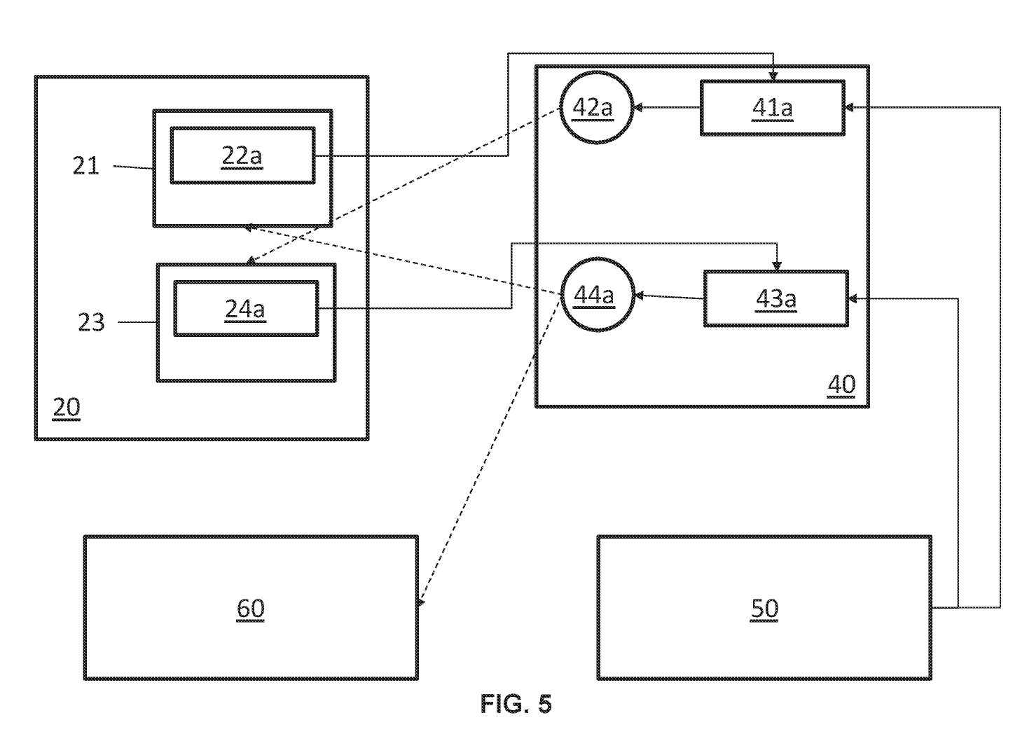

Components generated by a BPM system in accordance with a second embodiment of the invention are now described with reference to FIG. 5. The Coach 20 and business object 40 are as in the first embodiment, but for ease of understanding only the fields 22a and 24a of the first Coach View 21 and second Coach View 23 respectively, the fields 41a and 43a of the business object 40 that they are bound to, and their respective notification handlers 42a and 44a, are shown.

In addition, a transmitting object 50 is generated by the BPM system. The transmitting object 50 is able to update the fields 41a and 43a of the business object 40. In this way, the object 50 can pass information to the first Coach View 21 and second Coach View 23, in response to which they can take appropriate action. The transmitting object 50 may for example implement a separate script, and may be a part of the Coach 20, or a separate component.

Further, a receiving object 60 is generated by the BPM system. The receiving object 60 is attached to the notification handler 44a of the field 43a. In this way, the receiving object can identify changes made to the field 43a, so in a similar fashion to the first embodiment information can be transmitted from the second Coach View 23 to the third receiving object 60 to act upon as appropriate.

It will be appreciated that no changes are required to the first Coach View 21, second Coach View 23 or business object 40 in order to allow information to be transmitted to the receiving object 60 as well as between themselves. Rather, all that is required is for the receiving object 60 to be attached to the appropriate notification handlers of the fields of the business object 40. Thus, it can be seen that embodiments of the invention can provide a communication system similar to known publish-subscribe (“pub-sub”) communication systems, in which object (or the like) transmitting information does not need to have any information about the objects to which it is transmitting; it merely provides the information to be transmitted, and objects wishing to receive the information subscribe to it. (Where in embodiments of the invention, having a notification handler configured to monitor a field takes the place of a subscription.)

It will be appreciated that the invention is applicable to various different underlying hardware configurations. For example, the business objects and the like may be generated by the same or separate business process management systems, which may themselves run on the same or separate devices, such as servers or the like.

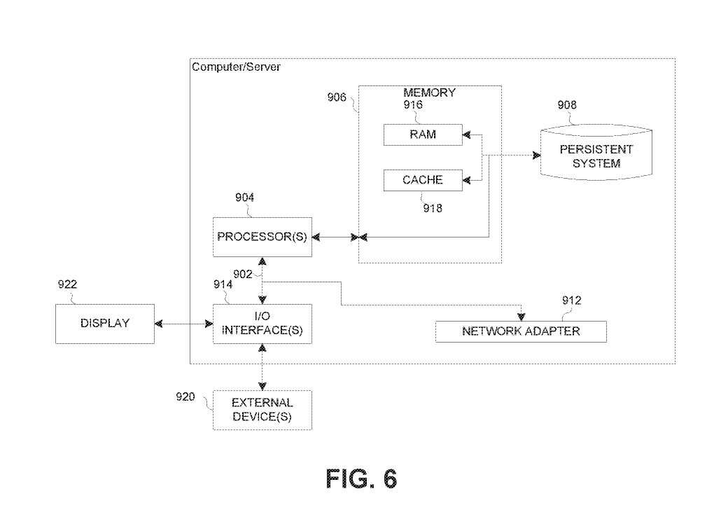

FIG. 6 depicts a block diagram of components of management device 110, first device 120 and second device 130, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Management device 110, first device 120 and second device 130 include communications fabric 902, which provides communications between computer processor(s) 904, memory 906, persistent storage 908, communications unit 912, and input/output (I/O) interface(s) 914. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses.

Memory 906 and persistent storage 908 are computer-readable storage media. In this embodiment, memory 906 includes random access memory (RAM) 916 and cache memory 918. In general, memory 906 can include any suitable volatile or non-volatile computer-readable storage media.

The programs BPM program 112 in management device 110; GUI 122 in first device 120; and GUI 132 in second device 130 are stored in persistent storage 908 for execution by one or more of the respective computer processors 904 via one or more memories of memory 906. In this embodiment, persistent storage 908 includes a magnetic hard disk drive. Alternatively, or in addition to a magnetic hard disk drive, persistent storage 908 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer-readable storage medium that is also part of persistent storage 908.

Communications unit 912, in these examples, provides for communications with other data processing systems or devices. In these examples, communications unit 912 includes one or more network interface cards. Communications unit 912 may provide communications through the use of either or both physical and wireless communications links. The programs BPM program 112 in management device 110; GUI 122 in first device 120; and GUI 132 in second device 130 may be downloaded to persistent storage 908 through communications unit 912.

I/O interface(s) 914 allows for input and output of data with other devices that may be connected to management device 110, first device 120 and second device 130. For example, I/O interface 914 may provide a connection to external devices 920 such as a keyboard, keypad, a touch screen, and/or some other suitable input device. External devices 920 can also include portable computer-readable storage media such as, for example, thumb drives, portable optical or magnetic disks, and memory cards. Software and data used to practice embodiments of the present invention, e.g., The programs BPM program 112 in management device 110; GUI 122 in first device 120; and GUI 132 in second device 130, can be stored on such portable computer-readable storage media and can be loaded onto persistent storage 908 via I/O interface(s) 914. I/O interface(s) 914 can also connect to a display 922.

Display 922 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

1-5. (canceled)

6. A computer program product for communicating information between first component and a second component in a business process management system, the computer program product comprising:
one or more computer-readable storage devices and program instructions stored on at least one of the one or more tangible storage devices, the program instructions comprising:
program instructions to generate a business object comprising one or more fields and one or more notification handlers corresponding to each of the one or more fields, wherein each of the one or more fields storing a value, and wherein each of the one or more notification handlers configured to identify a change in the value stored in the corresponding field of the business object;
program instructions to determine an update of a field of a first component, wherein the first component comprises one or more fields corresponding to the one or more fields of the business object, wherein each of the one or more fields of the first component is bound to the corresponding field of the business object;
program instructions to receive the updated field from the first component;
program instructions to update the corresponding field of the business object based on the received update from the field of the first component;
the notification handler of the field of the business object containing program instructions to notify a second component that the field has been updated, wherein the second component is bound to the notification handlers of the one or more fields of the business object; and
program instructions to perform an action by the second component in response to the updated value.

7. The computer program product of claim 6, wherein the first component is a web-based user interface widget.

8. The computer program product of claim 6, wherein the second component is a web-based user interface widget.

9. The computer program product of claim 6, further comprising:
program instructions to update the value stored by a field of its one or more fields by a third component, wherein the third component comprises one or more fields corresponding to the one or more fields of the business object, and wherein each of the one or more fields of the third component is bound to the corresponding field of the business object;
the corresponding field of the business object being updated in response to the field of the third component being updated; and
program instructions to perform an action in response to the updated value by the second component.

10. The computer program product of claim 6, wherein:
the second component comprises one or more fields corresponding to one or more fields of the business object, and wherein each of the one or more fields of the second component is bound to the corresponding field of the business object; and
the first component is attached to the notification handlers of the one or more fields of the business object;
the method further comprising the steps of:
program instructions to update the value stored by a field of its one or more fields by the second component;
the corresponding field of the business object being updated in response to the field of the second component being updated; and
the first component performing an action in response to the updated value.

11. A computer system for communicating information between first component and a second component in a business process management system, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to generate a business object comprising one or more fields and one or more notification handlers corresponding to each of the one or more fields, wherein each of the one or more fields storing a value, and wherein each of the one or more notification handlers configured to identify a change in the value stored in the corresponding field of the business object;
program instructions to determine an update of a field of a first component, wherein the first component comprises one or more fields corresponding to the one or more fields of the business object, wherein each of the one or more fields of the first component is bound to the corresponding field of the business object;
program instructions to receive the updated field from the first component;
program instructions to update the corresponding field of the business object based on the received update from the field of the first component;
the notification handler of the field of the business object containing program instructions to notify a second component that the field has been updated, wherein the second component is bound to the notification handlers of the one or more fields of the business object; and
program instructions to perform an action by the second component in response to the updated value.

12. The system of claim 11, wherein the first component is a web-based user interface widget.

13. The system of claim 11, wherein the second component is a web-based user interface widget.

14. The system of claim 11, further comprising:
program instructions to update the value stored by a field of its one or more fields by a third component, wherein the third component comprises one or more fields corresponding to the one or more fields of the business object, and wherein each of the one or more fields of the third component is bound to the corresponding field of the business object;
the corresponding field of the business object being updated in response to the field of the third component being updated; and
program instructions to perform an action in response to the updated value by the second component.

15. The system of claim 11, wherein:
the second component comprises one or more fields corresponding to one or more fields of the business object, and wherein each of the one or more fields of the second component is bound to the corresponding field of the business object; and
the first component is attached to the notification handlers of the one or more fields of the business object;
the method further comprising the steps of:
program instructions to update the value stored by a field of its one or more fields by the second component;
the corresponding field of the business object being updated in response to the field of the second component being updated; and
the first component performing an action in response to the updated value.
